(19) United States
(12) Patent Application Publication
(10) Pub. No.: US 2009/0011229 A1
(43) Pub. Date: Jan. 8, 2009

(54) OPTICAL MULTILAYER BODY

(75) Inventors: Masataka Nakashima, Okayama-Ken (JP); Takeshi Hirai, Okayama-Ken (JP); Yoko Kinoshita, Okayama-Ken (JP)

Correspondence Address: BURR & BROWN, PO BOX 7068, SYRACUSE, NY, 13261-7068, US

(73) Assignee: DAI NIPPON PRINTING CO., LTD., TOKYO (JP)

(21) Appl. No.: 11/817,832

(22) PCT Filed: Mar. 17, 2006
(86) PCT No.: PCT/JP2006/305376

§ 371 Date: Apr. 21, 2008

(30) Foreign Application Priority Data
Mar. 30, 2005 (JP) 2005-098034

(51) Int. Cl. B32B 27/00

(52) U.S. Cl. 428/339

(57) ABSTRACT

There is provided an optical laminate comprising a hard coat layer which is excellent in an antistatic effect as well as in optical properties. The optical laminate comprises a base material; and a hard coat layer provided on the base material directly or through other layer, wherein the hard coat layer comprises a resin and electroconductive fine particles, has a PV value, defined by the ratio of the weight of the electroconductive fine particles to the weight of the resin, in the range of 3 to 50, and has an antistatic property.

### TECHNICAL FIELD

The present invention provides an optical laminate comprising a hard coat layer having an excellent antistatic effect and excellent optical properties

### BACKGROUND ART

A reduction in reflection of light applied from external light sources such as fluorescent lamps and an enhancement in the visibility of image are required of an image display face in image display devices such as liquid crystal displays (LCDs), cathode ray tube display devices (CRTs), and plasma displays (PDPs). On the other hand, an improvement in visibility by reducing the reflection from a display face of an image display device has been made by providing an optical laminate (for example, an antireflection laminate) which has realized reduction in reflectance by covering the surface of a transparent object with a transparent low-refractive index film.

Further, for example, from the viewpoint of contamination preventive properties of the display face of image display devices, it is common practice to provide an antistatic layer in the optical laminate. For example, patent document 1 (Japanese Patent Laid-Open No. 94007/2004) proposes an antireflection optical laminate comprising an antistatic layer and a hard coat layer provided in that order smoothly on a surface of a light transparent base material. Further, excellent scratch resistance is required of the outermost surface of the image display device. To this end, the provision of the hard coat layer is indispensable.

It is not easy to effectively impart all of hard coating properties, antistatic properties, and light transparency to the optical laminate.

Further, in general, in order to simultaneously realize hard coating properties and antistatic properties, a method has been proposed in which both the functions are imparted by providing different layers for imparting respective functions rather than the provision of a single layer (for example, patent document 2). Specifically, in the prior art, a method has been adopted in which a thin electroconductive layer is formed for antistatic purposes and any hard coat layer is provided on the surface of the electroconductive layer. Accordingly, at the present time, any technique, which could realized these both functions by a single layer, has not been developed yet.

On the other hand, the present inventors has made studies on the possibility of simultaneously imparting antistatic properties and hard coating properties to the hard coat layer. As a result, the present inventors have found the following facts. Specifically, in order to imparting antistatic properties to the hard coat layer, a relatively large amount of electroconductive particles should be incorporated. For example, when electroconductive fine particles of ATO or the like are dispersed in an UV curing resin, the primary particle diameter of the electroconductive fine particles should be limited to not more than about 150 nm from the viewpoint of suppressing haze. When the above electroconductive fine particles are used as an antistatic agent, for example, the weight ratio of electroconductive fine particles/resin (PV value) should be brought to not less than 150. This is because, when the PV value is less than 150, electroconductive ultrafine particles do not come into contact well with each other, or the antistatic property is not developed.

The above high PV value poses a new problem that the light transmittance of the optical laminate per se is disadvantageously lowered, that is, an increase in haze value or a lowering in total light transmittance occurs. Further, since the relative amount of the resin is reduced, the scratch resistance and the pencil hardness are also disadvantageously lowered. Furthermore, most of the electroconductive fine particles are formed of materials having a relatively high refractive index, and, thus, a refractive index of the hard coat layer is increased.

An increase in refractive index of the hard coat layer causes an increase in difference in refractive index between the hard coat and a layer in contact with the hard coat in optical laminates such as antireflection laminates, leading to a problem that interfacial reflection and interference fringes often occur in the interface of the hard coat and the layer in contact with the hard coat. In particular, it has been pointed out that, in the interface of the light transparent base material and the antistatic layer, interference fringes occur and the visibility of images is lowered. Further, also from the viewpoint of realizing good optical properties as an antireflection laminate, the refractive index of the hard coat layer should be regulated to a value of the refractive index of each base material about 0.03.

For example, when a polyethylene terephthalate (PET) film (U46, 100 μm: manufactured by Toray Industries, Inc.) for interference fringe prevention purposes is used as the base material, the refractive index of the base material and the refractive index of the primer layer necessary for providing the adhesion to the hard coat layer provided on the base material are 1.65 and 1.55 to 1.57, respectively. This primer layer is designed so as not to cause interference fringes between the primer layer and the hard coat having a refractive index of 1.50. Accordingly, in this case, it is generally regarded that the refractive index of the hard coat layer is preferably design standard refractive index value 1.50±about 0.03, that is, about 1.47 to 1.53.

[Patent document 1] Japanese Patent Laid-Open No. 94007/2004

[Patent document 2] Japanese Patent Laid-Open No. 42729/1999

### DISCLOSURE OF INVENTION

### Problem to be Solved by the Invention

The present invention is directed to the solution of the above technical problems of the prior art, and the present invention provides an optical laminate comprising a hard coat layer which is excellent in antistatic effect as well as in optical properties.

According to the finding of the present inventors, the incorporation of electroconductive fine particles in a relatively small amount in a specific range in a resin unexpectedly causes electrification of the resin layer. This is considered attributable to the formation of a three-dimensional network structure of electroconductive fine particles dispersed in the resin layer by a specific aggregation method.

Thus, according to the present invention, there is provided an optical laminate comprising: a base material; and a hard coat layer provided on the base material directly or through other layer, characterized in that the hard coat layer comprises a resin and electroconductive fine particles, has a PV value, defined by the ratio of the weight of the electroconductive fine particles to the weight of the resin, in the range of 3 to 50, and has an antistatic property, and preferably the refractive index of the hard coat layer can be regulated to a value in the range of about 1.47 to 1.53.

In the optical laminate according to the present invention, the hard coat layer has electroconductive properties and antistatic properties and thus can function also as an antistatic layer.

Further, in the optical laminate according to the present invention, preferably, when the thickness of the hard coat layer is not less than 1 μm and not more than 20 μm, preferably is not less than 1 μm and not more than 10 μm, the level of an increase in haze, when the electroconductive fine particles are contained in the hard coat layer, based on the haze of the case where the electroconductive fine particles are not contained in the hard coat layer, is not more than 0.5%.

Furthermore, in the optical laminate according to the present invention, preferably, an electroconductive path is provided between the front side and back side of the hard coat layer by forming a structure comprising the electroconductive fine particles aggregated and dispersed in a three-dimensional network form in the resin.

In another embodiment of the optical laminate according to the present invention, a low-refractive index layer may be further provided on the surface of the hard coat layer.

Further, the present invention includes use of the above optical laminate as an antireflection laminate and an image display device comprising the optical laminate.

### EFFECT OF THE INVENTION

According to the present invention, a hard coat layer, which as such can function also as an antistatic layer and, at the same time, has excellent optical properties, can be provided. An excellent effect can be provided particularly in the application of optical laminates utilized in the field of displays.

### BEST MODES FOR CARRYING OUT THE INVENTION

The optical laminate according to the present invention comprises: a base material; and a hard coat layer provided on the base material directly or through other layer, characterized in that the hard coat layer comprises a resin and electroconductive fine particles, has a PV value, defined by the ratio of the weight of the electroconductive fine particles to the weight of the resin, in the range of 3 to 50, and has an antistatic property, and the refractive index of the hard coat layer can be regulated to a value in the range of about 1.47 to 1.53.

Base Material

The light transparent base material is preferably smooth and possesses excellent heat resistance and mechanical strength. Specific examples of materials usable for the light transparent base material formation include thermoplastic resins, for example, polyesters (polyethylene terephthalate and polyethylene naphthalate), cellulose triacetate, cellulose diacetate, cellulose acetatebutyrate, polyesters, polyamides, polyimides, polyethersulfone, polysulfone, polypropylene, polymethylpentene, polyvinyl chloride, polyvinylacetal, polyetherketone, polymethyl methacrylate, polycarbonate, and polyurethane. Preferred are polyesters (polyethylene terephthalate and polyethylene naphthalate) and cellulose triacetate.

Films of amorphous olefin polymers (cycloolefin polymers: COPs) having an alicyclic structure may also be mentioned as other examples of the light transparent base material. These films are base materials using nobornene polymers, monocyclic olefinic polymers, cyclic conjugated diene polymers, vinyl alicyclic hydrocarbon polymer resins and the like, and examples thereof include Zeonex and ZEONOR, manufactured by Zeon Corporation (norbornene resins), Sumilight FS-1700 manufactured by Sumitomo Bakelite Co., Ltd., ARTON (modified norbornene resin) manufactured by JSR Corporation, APL (cyclic olefin copolymer) manufactured by Mitsui Chemicals Inc., Topas (cyclic olefin copolymer) manufactured by Ticona, and Optlet OZ-1000 series (alicyclic acrylic resins) manufactured by Hitachi Chemical Co., Ltd. Further, FV series (low birefringent index and low photoelastic films) manufactured by Asahi Kasei Chemicals Corporation are also preferred as base materials alternative to triacetylcellulose.

The thickness of the light transparent base material is not less than 20 μm and not more than 300 μm. Preferably, the upper limit of the thickness is 200 μm, and the lower limit of the thickness is 30 μm. When the light transparent base material is a plate-like material, the thickness may be above the upper limit of the above-defined thickness range. In forming an optical properly layer on the light transparent base material, the light transparent base material may be previously subjected to physical treatment such as corona discharge treatment or oxidation treatment or may be previously coated with an anchoring agent or a composition known as a primer from the viewpoint of improving the adhesion.

Hard Coat Layer

The term “hard coat layer” as used herein refers to a layer having a hardness of “H” or higher as measured by a pencil hardness test specified in JIS 5600-5-4 (1999). The thickness (in a cured state) of the hard coat layer is 0.1 to 100 μm, preferably 0.8 to 20 μm.

In the present invention, the hard coat layer comprises a resin and electroconductive fine particles. The electroconductive fine particles function as an antistatic agent.

Electroconductive Fine Particles

In the present invention, the hard coat layer comprises the above resin and electroconductive fine particles and has a PV value, defined by the ratio of the weight of the electroconductive fine particles to the weight of the electroconductive fine particles, of 3 to 50.

Specific examples of electroconductive ultrafine particles include ultrafine particles of metal oxides. Such metal oxides include ZnO (refractive index 1.90; the numerical values within the parentheses being refractive index; the same shall apply hereinafter), CeO₂ (1.95), Sb₂O₂ (1.71), SnO₂ (1.997), indium tin oxide often abbreviated to “ITO” (1.95), In₂O₃ (2.00), Al₂O₃ (1.63), antimony-doped tin oxide (abbreviated to “ATO,” 2.0), and aluminum-doped zinc oxide (abbreviated to “AZO,” 2.0). Among the above electroconductive fine particles, fine particles of ATO are particularly preferred.

In the present invention, the term “fine particles” refers to fine particles having a size of not more than 1 micrometer, that is, fine particles of submicron size, preferably fine particles having an average particle diameter of 0.1 nm to 0.1 μm. In a preferred embodiment of the present invention, the fine particles have a primary particle diameter of approximately 20 to 70 nm and a secondary particle diameter of approximately not more than 200 nm.

In the present invention, the PV value defined by the ratio of the electroconductive fine particles to the weight of the resin is 3 to 50, preferably 5 to 20, more preferably 5 to 10.

When the PV value is less than 3, the formation of an electroconductive path, which will be described later, is so difficult that the development of the electroconductive property is unsatisfactory. On the other hand, when the PV value exceeds 50, there is a tendency toward a lowering in hardness, a lowering in total light transmittance, and an increase in refractive index of the film. Accordingly, the PV value should be regulated to a value in the above-defined range.

As described above, the present invention is characterized in that, despite the fact that the weight ratio of the electroconductive fine particles in the hard coat layer is unexpectedly low, electroconductivity on a level satisfactory for antistatic purposes can be realized. The development mechanism of the electroconductivity has not been fully elucidated yet. Without wishing to be bound by theory, however, the development mechanism can be believed to be as follows.

Specifically, it is believed that the electroconductive fine particles added in a relatively small amount form a three-dimensional network structure within the resin layer by a specific aggregation method, whereby a “electroconductive path” comprising electroconductive fine particles connected to one another from the surface of the layer to the backside of the layer is formed. More specifically, it is considered that the matrix resin constituting the hard coat layer causes phase separation resulting in the formation of aggregates, and the hydrophilic groups on the surface of the aggregates are exposed and consequently adsorb electroconductive fine particles of ATO or the like, whereby the electroconductive fine particles are locally present on the surface of the aggregates. The electroconductive fine particles locally present in the aggregates come into contact with each other at contact points of the aggregates. Consequently, connection of electroconductive fine particles led from the surface of the hard coat layer to the backside of the hard coat layer, that is, an electroconductive path is formed. It is considered that, by virtue of the formation of the electroconductive path by the localization of the particles, the absolute amount of the electroconductive fine particles necessary for the development of the electroconductive property can be significantly reduced as compared with the case where the electroconductive fine particles are dispersed in the whole matrix resin.

Further, the level of localization of the electroconductive fine particles on the surface of the aggregates can be controlled by controlling the hydrophobicity of the electroconductive fine particles, and, thus, the electroconductivity can be controlled to an optimal state.

In an antireflection laminate comprising layers, of which the difference in refractive index therebetween is significant, stacked on top of each other, interface reflection and interference fringes often occur in the interface of mutually superimposed layers. It is particularly pointed out that, in the interface of the light transparent base material and the antistatic layer, interference fringes occurs, resulting in lowered visibility of images. In the present invention, since the refractive index of the hard coat layer (1.47 to 1.53) can be regulated by the above dispersion of the electroconductive fine particles. Accordingly, the present invention is also advantageous in that the occurrence of the interference fringes can be effectively prevented.

Matrix Resin

In the present invention, curable resin precursors such as monomers, oligomers, and prepolymers are collectively referred to as “resin” unless otherwise specified.

The resin constituting the hard coat layer is preferably transparent, and specific examples thereof are classified into ionizing radiation curing resins which are curable upon exposure to ultraviolet light or electron beams, mixtures of ionizing radiation curing resins with solvent drying-type resins (resins, which are formed into films by merely removing a solvent, added for regulating the solid content in the coating, by drying, for example, thermoplastic resins), or heat curing resins. Preferred are ionizing radiation curing resins.

Specific examples of ionizing radiation curing resins include those containing an acrylate-type functional group, for example, oligomers or prepolymers and reactive diluents, for example, relatively low-molecular weight polyester resins, polyether resins, acrylic resins, epoxy resins, urethane resins, alkyd resins, spiroacetal resins, polybutadiene resins, and polythiol polyene resins and (meth)acrylates of polyfunctional compounds such as polyhydric alcohols. Specific examples thereof include monofunctional monomers such as ethyl (meth)acrylate, ethylhexyl (meth)acrylate, styrene, methyl styrene, and N-vinylpyrrolidone, and polyfunctional monomers, for example, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

When the ionizing radiation curing resin is an ultraviolet curing resin, a photopolymerization initiator is preferably used. In the case of radical polymerizable unsaturated group-containing resin systems, specific examples of photopolymerization initiators usable herein include acetophenones, benzophenones, Michler's benzoyl benzoate, α-amyloxime ester, tetramethylthiuram monosulfide, thioxanthones, propiophenones, benzyls, benzoins, and acylphosphine oxides. On the other hand, in the case of cation polymerizable functional group-containing resin systems, specific examples of photopolymerization initiators usable herein include aromatic diazonium salts, aromatic sulfonium salts, aromatic iodonium salts, metallocene compounds, and benzoinsulfonic esters. They may be used either solely or as a mixture of two or more. The amount of the photopoloymerization initiator added is 0.1 to 10 parts by weight based on 100 parts by weight of the ionizing radiation curing composition. Further, preferably, a photosensitizer is mixed in the system. Specific examples of photosensitizers include n-butylamine, triethylamine, and poly-n-butylphosphine.

The solvent drying-type resin used as a mixture with the ionizing radiation curing resin is mainly a thermoplastic resin. Commonly exemplified thermoplastic resins are usable. Coating defects of the coated face can be effectively prevented by adding the solvent drying-type resin. Specific examples of preferred thermoplastic resins include styrenic resins, (meth)acrylic resins, vinyl acetate resins, vinyl ether resins, halogen-containing resins, alicyclic olefinic resins, polycarbonate resins, polyester resins, polyamide resins, cellulose derivatives, silicone resins, and rubbers or elastomers. The resin is generally noncrystalline and, at the same time, is soluble in an organic solvent (particularly a common solvent which can dissolve a plurality of polymers and curable compounds). Particularly preferred are resins having good moldability or film forming properties, transparency, and weathering resistance, for example, styrenic resins, (meth)acrylic resins, alicyclic olefinic resins, polyester resins, and cellulose derivatives (for example, cellulose esters).

In a preferred embodiment of the present invention, when the transparent base material is formed of a cellulosic resin such as triacetylcellulose “TAC,” specific examples of preferred thermoplastic resins include cellulosic resins, for example, nitrocellulose, acetylcellulose, cellulose acetate propionate, and ethylhydroxyethylcellulose.

In a preferred embodiment of the present invention, when the light transparent base material is formed of a cellulosic resin such as triacetylcellulose “TAC,” specific examples of preferred thermoplastic resins include cellulosic resins, for example, nitrocellulose, acetylcellulose, cellulose acetate propionate, and ethylhydroxyethylcellulose. When the cellulosic resin is used, the adhesion between the light transparent base material and the antistatic layer (if any) and transparency can be improved.

Specific examples of heat curing resin include phenolic resins, urea resins, diallyl phthalate resins, melanin resins, guanamine resins, unsaturated polyester resins, polyurethane resins, epoxy resins, aminoalkyd resins, melamine-urea cocondensed resins, silicone resins, and polysiloxane resins. When the heat curing resin is used, if necessary, for example, curing agents such as crosslinking agents and polymerization initiators, polymerization accelerators, solvents, and viscosity modifiers may be further added.

In the formation of the hard coat layer, a photopolymerization initiator may be used. Specific examples thereof include 1-hydroxy-cyclohexyl-phenyl-ketone. This compound is commercially available, for example, under the designations Irgacure 184 (manufactured by Ciba Specialty Chemicals, K.K.). Specific examples of other photopolymerization initiators include acetophenones, benzophenones, Michler's benzoyl benzoate, α-amyloxime ester, thioxanthones, propiophenones, benzyls, benzoins, and acylphosphine oxides. Preferably, photosensitizers are mixed in the system. Specific examples of photosensitizers include n-butylamine, triethylamine, and poly-n-butylphosphine.

In the case of radical polymerizable unsaturated group-containing resin systems, examples of photopolymerization initiators usable herein include acetophenones, benzophenones, thioxanthones, benzoins, and benzoin methyl ethers. They may be used either solely or as a mixture of two or more. On the other hand, in the case of cation polymerizable functional group-containing resin systems, examples of photopolymerization initiators usable herein include aromatic diazonium salts, aromatic sulfonium salts, aromatic iodonium salts, metallocene compounds, and benzoinsulfonic esters. They may be used either solely or as a mixture of two or more. The amount of the photopoloymerization initiator added is 0.1 to 10 parts by weight based on 100 parts by weight of the ionizing radiation curing composition.

In order to cause phase separation and aggregate formation of the matrix resin for accelerating the formation of an electroconductive path by the localization of the electroconductive fine particles, preferably, a resin component is properly used in combination with other additives.

Dispersing Agent

A dispersing agent may also be used from the viewpoint of accelerating good localization. Such dispersing agents include, for example, higher fatty acid esters such as polyglycerin fatty acid esters, sorbitan fatty acid esters, and sucrose fatty acid esters. Polyglycerin fatty acid esters are preferred. In particular, for the polyglycerin, in addition to a straight chain polyglycerin condensed at the α-position, a branched polyglycerin condensed at the β-position and a cyclic polyglycerin may be partially contained. Preferably, the polyglycerin constituting the polyglycerin fatty acid ester has a number average degree of polymerization of about 2 to 20, more preferably about 2 to 10, from the viewpoint of realizing better dispersion state. The fatty acid is preferably a branched or straight chain saturated or unsaturated fatty acid, and examples thereof include aliphatic monocarboxylic acids, for example, caproic acid, enanthylic acid, caprylic acid, nonanoic acid, capric acid, lauric acid, myristic acid, behenic acid, palmitic acid, isostearic acid, stearic acid, oleic acid, isononanoic acid, and arachic acid. Particularly preferred polyglycerin fatty acid esters used as the higher fatty acid ester include Ajisper-PN-411 and PA-111 manufactured by Ajinomoto Fine-Techno Co., Inc. and SY-Glyster manufactured by SAKAMOTO YAKUHIN KOGYO CO., LTD.

In addition to the above dispersing agents, various other dispersing agents such as sulfonic acid amide, ε-caprolactone, hydrostearic acid, polycarboxylic acid, and polyester dispersing agents may be used. Specific examples thereof include Solpers 3000, Solpers 9000, Solpers 17000, Solpers 20000, Solpers 24000, and Solpers 41090 (all the above products being manufactured by ZENECA), and Disperbyk-161, Disperbyk-162, Disperbyk-163, Disperbyk-164, Disperbyk-108, Disperbyk-110, Disperbyk-111, Disperbyk-112, Disperbyk-116, Disperbyk-140, Disperbyk-170, Disperbyk-171, Disperbyk-174, Disperbyk-180, Disperbyk-182, and Disperbyk-220S (all the above products being manufactured by Bik-Chemie Japan K.K.).

The electroconductive fine particles may be dispersed by various dispersion methods, for example, by using pulverizers such as ultrasonic mills, bead mills, sand mills, or disk mills.

Solvent

In forming a hard coat layer, a composition for a hard coat layer prepared by mixing the above resin composition and electroconductive fine particles with a solvent is utilized.

The solvent may be selected and used according to the type, solubility, and dispersibility of the electroconductive fine particles of the resin component: polymer and curable resin precursor. A solvent capable of homogeneously dissolving at least the solid matter (a plurality of polymers and curable resin precursor, a reaction initiator, and other additives) suffices for contemplated results. Examples of such solvents include ketones (for example, acetone, methyl ethyl ketone, methyl isobutyl ketone, and cyclohexanone), ethers (for example, dioxane and tetrahydrofuran), aliphatic hydrocarbons (for example, hexane), alicyclic hydrocarbons (for example, cyclohexane), aromatic hydrocarbons (for example, toluene and xylene), halogenated hydrocarbons (for example, dichloromethane and dichloroethane), esters (for example, methyl acetate, ethyl acetate and butyl acetate), water, alcohols (for example, ethanol, isopropanol, butanol, and cyclohexanol), cellosolves (for example, methylcellosolve and ethylcellosolve), cellosolve acetates, sulfoxides (for example, dimethylsulfoxide), and amides (for example, dimethylformamide and dimethylacetamide). A mixture solvent composed of two or more of these solvents may also be used. Preferred are ketones and esters.

Formation of Hard Coat Layer

The hard coat layer may be formed by coating a composition, prepared by mixing the above resin, solvent and optional component and electroconductive fine particles, onto a light transparent base material. In a preferred embodiment of the present invention, a leveling agent such as a fluoro or silicone leveling agent is added to the liquid composition. The liquid composition to which a leveling agent has been added can impart contamination preventive properties and scratch resistance.

Methods usable for coating the composition onto the light transparent base material include coating methods such as roll coating, Mayer bar coating, and gravure coating. After coating of the liquid composition, the coating is dried and cured by ultraviolet irradiation. Specific examples of ultraviolet sources include light sources, for example, ultra-high-pressure mercury lamps, high-pressure mercury lamps, low-pressure mercury lamps, carbon arc lamps, black light fluorescent lamps, and metal halide lamps. Regarding the wavelength of the ultraviolet light, a wavelength range of 190 to 380 nm may be used. Specific examples of electron beam sources include various electron beam accelerators, for example, Cockcroft-Walton accelerators, van de Graaff accelerators, resonance transformer accelerators, insulated core transformer accelerators, linear accelerators, Dynamitron accelerators, and high-frequency accelerators.

Use of Optical Laminate

The optical laminate according to the present invention is utilized as a hard coat laminate or an antireflection laminate. Further, the optical laminate according to the present invention is utilized in transmission display devices, particularly displays such as cathode ray tube display devices (CRTs), plasma displays (PDPs), electroluminescence displays (ELDs), and liquid crystal displays (LCDs). Among others, the optical laminate according to the present invention is used on the outermost surface of displays such as CRTs, PDPs, and liquid crystal panels.

### EXAMPLES

The present invention is further illustrated by the following Examples that are not intended as a limitation of the invention.

### Production Example

The following composition for a hard coat layer was coated onto a PET base material (U46 (thickness 100 μm): manufactured by Toray Industries, Inc.) to form an about 5 μm-thick hard coat layer.

(Composition for hard coat layer)

| | |
|---|---|
| <Hard coat component> | |
| (1) ATO (average primary particle diameter 30 nm, ITO, | |
| manufactured by Mitsubishi Materials Corporation) | |
| (2) Pentaerythritol triacrylate resin (PET-30, manufactured | |
| by Nippon Kayaku Co., Ltd.) | |
| The total amount of (1) and (2) was regulated to 50 g. | |
| <Dispersing agent> | 1 g |
| (Ajisper PN-411: manufactured by | |
| Ajinomoto Fine-Techno Co., Inc.) | |
| <Dilution solvent> | 50 g |
| Isopropyl alcohol | |

For compositions with the ATO:resin weight ratio (%) (PV value) in the hard coat component being varied in a range from 0 to 150, a hard coat layer was formed and was measured for total light transmittance, haze, surface resistivity (applied voltage 1000 V), and film refractive index. The results are shown below.

The haze value may be measured according to JIS K 7136. A reflection-transmittance meter HM-150 (Murakami Color Research Laboratory) may be mentioned as an instrument used for the measurement.

The total light transmittance may be measured with the same measuring device as in the haze value according to JIS K 7361. The haze and total light transmittance are measured in such a state that the coated face is directed to a light source.

The surface resistivity (Ω/□) was measured by providing a surface resistivity measuring device (Product No.; Hiresta IP MCP-HT260: manufactured by Mitsubishi Chemical Corporation), placing 15 sheets of clean paper (SC75RB) manufactured by SAKURAI on a table having a flat surface and applying a voltage of 1000 V to measure the surface resistivity. The refractive index of the hard coat was measured with an Abbe refractometer NAR-1T manufactured by Atago Co., Ltd.

The surface hardness of the hard coat was evaluated by a scratch resistance evaluation test. Specifically, a steel wool #0000 was provided and reciprocated on the surface of the hard coat layer in the optical laminate 10 times under a predetermined frictional load (300 g/cm²), and the optical laminate was then visually inspected for the separation of the coating film. The results were evaluated according to the following criteria.

◯: No scratch was observed.

Δ: 10 or less streaks of scratches occurred.

x: More than 10 streaks of scratches occurred.

Interference fringes were evaluated as follows. Specifically, in order to prevent the backside reflection of the optical laminate, a black tape was applied to the optical laminate on its side remote from the hard coat layer, and, in this state, the optical laminate was visually observed from the face of the hard coat layer under three-wavelength fluorescence, and the results were evaluated according to the following evaluation criteria.

Evaluation Criteria

◯: Interference fringes were not observed in visual observation in all directions.

x: Interference fringes were observed in visual observation in all directions.

TABLE 1

| | Total light | | Surface resistivity | Film refractive | Surface | Interference |
|---|---|---|---|---|---|---|
| PV | transmittance (%) | Haze (%) | (Ω/□) | index | hardness | fringes |
| 0 | 91.5 | 0.4 | Over range | 1.477 | ∘ | ∘ |
| 1 | 91.2 | 0.5 | Over range | 1.477 | ∘ | ∘ |
| 3 | 90.5 | 0.5 | 3.5 × 10¹² | 1.478 | ∘ | ∘ |
| 5 | 90.3 | 0.5 | 5.0 × 10¹⁰ | 1.479 | ∘ | ∘ |
| 7 | 90.0 | 0.5 | 4.0 × 10¹⁰ | 1.479 | ∘ | ∘ |
| 10 | 89.5 | 0.5 | 4.0 × 10¹⁰ | 1.481 | ∘ | ∘ |
| 20 | 88.0 | 0.5 | 4.9 × 10⁹ | 1.484 | ∘ | ∘ |
| 30 | 87.0 | 0.5 | 3.6 × 10⁹ | 1.488 | ∘ | ∘ |
| 40 | 86.0 | 0.5 | 3.1 × 10⁹ | 1.491 | ∘ | ∘ |
| 50 | 85.0 | 0.5 | 2.8 × 10⁹ | 1.485 | ∘ | ∘ |
| 60 | 81.0 | 0.5 | 1.4 × 10⁹ | 1.498 | Δ | ∘ |
| 150 | 70.3 | 1.7 | 6.3 × 10⁶ | 1.602 | x | x |

As is apparent from the results of Examples, the hard coat layer according to the present invention wherein the PV value defined by the ratio of the weight of the electroconductive fine particles to the weight of the resin has been regulated to a value in the range of 3 to 50, is advantageous in that good electroconductivity can be developed, the hard coat layer can be satisfactorily effectively functioned as an antistatic layer, and, at the same time, the lowering in total light transmittance can be prevented, and a good haze value can be realized. Further, an increase in film refractive index can also be prevented, that is, the refractive index can be regulated to 1.47 to 1.53. Accordingly, the occurrence of interference fringes can be effectively prevented, for example, in the case where the base material is a polyethylene terephthalate (PET) base material (an interference fringes preventive easy-adhesion layer) subjected to interference fringe suppression treatment, and the case where the base material is a triacetylcellulose base material.

In the above results, when the PV value is less than 3, particularly 0.1, the surface resistivity property is unsatisfactory. On the other hand, when the PV value is 60, the total light transmittance is less than 85%, resulting in unsatisfactory optical properties. Accordingly, in order to provide good optical properties, it is important that the PV value is not more than 50. In Comparative Example wherein the PV value is large, in the case of a PV value of 150 which has been necessary in the prior art technique for imparting antistatic properties, the total light transmittance is low and 70.3% and, at the same time, the haze value is also high, and the refractive index is higher than 1.53. Accordingly, in this case, the prevention of interference fringes is impossible, and the surface hardness as measured by the steel wool test is also lowered. Consequently, good optical properties and physical properties cannot be realized.

1. An optical laminate comprising a base material and a hard coat layer provided on the base material directly or through other layer,
the hard coat layer comprising a resin and electroconductive fine particles, wherein a PV value defined by the ratio of the weight of the electroconductive fine particles to the weight of the resin is in the range of 3 to 50, and
the hard coat layer comprising an antistatic property.

2. The optical laminate according to claim 1, wherein the hard coat layer functions also as an antistatic layer.

3. The optical laminate according to claim 1, wherein the level of an increase in haze of the optical laminate is not more than 0.5% when the electroconductive fine particles are contained in the hard coat layer based on the haze of the case where the electroconductive fine particles are not contained in the hard coat layer, under the thickness of the hard coat layer is not less than 1 μm and not more than 20 μm.

4. The optical laminate according to claim 1, wherein an electroconductive path is provided between the front side and back side of the hard coat layer by forming a structure comprising the electroconductive fine particles aggregated and dispersed in a three-dimensional network form in the resin.

5. Use of an optical laminate according to claim 1 as an antireflection laminate.

6. An image display device comprising an optical laminate according to claim 1.
